(19) United States
(12) Patent Application Publication
(10) Pub. No.: US 2024/0274998 A1
(43) Pub. Date: Aug. 15, 2024

(54) NEGATIVE THERMAL EXPANSION BASED PROTECTIVE MECHANISMS FOR BATTERY CELLS

(71) Applicant: American Lithium Energy Corporation, Carlsbad, CA (US)

(72) Inventor: Jiang FAN, San Diego, CA (US)

(73) Assignee: American Lithium Energy Corporation, Carlsbad, CA (US)

(21) Appl. No.: 18/460,251

(22) Filed: Sep. 1, 2023

Related U.S. Application Data
(60) Provisional application No. 63/374,479, filed on Sep. 2, 2022.

(51) Int. Cl. H01M 50/581; H01M 50/534

(52) U.S. Cl. CPC H01M 50/581; H01M 50/534; H01M 2200/10

(57) ABSTRACT

A battery cell may include a first electrode coupled with a first current collector, a second electrode coupled with a second current collector, and a separator interposed between the first electrode and the second electrode. The battery cell may further include a negative thermal expansion (NTE) current interrupter including a pyrophosphate. The negative thermal expansion (NTE) current interrupter may be interposed between the first electrode and the first current collector and/or the separator and at least one of the first electrode and the second electrode. The negative thermal expansion (NTE) current interrupter may respond to a temperature trigger by contracting, which includes a decrease in a size of the negative thermal expansion (NTE) current interrupter along one or more dimensions. The contraction of the negative thermal expansion (NTE) current interrupter may form a nonconductive gap that disrupts a current flow within the battery cell.

### CROSS REFERENCE TO RELATED APPLICATION

This application claims priority to U.S. Provisional Application No. 63/374,479, entitled “NEGATIVE THERMAL EXPANSION BASED PROTECTIVE MECHANISM FOR PREVENTING INTERNAL SHORT CIRCUITS AND OVERCHARGING IN A BATTERY CELL” and filed on Sep. 2, 2022, the disclosure of which is incorporated herein by reference in its entirety.

### TECHNICAL FIELD

The subject matter described herein relates generally to battery technology and more specifically to negative thermal expansion (NTE) based protective mechanisms in a battery cell for mitigating the hazards associated with internal short circuits and overcharging.

### BACKGROUND

The high energy density and high current output of metal ion battery cells, such as lithium (Li) ion battery cells, render metal ion battery cells suitable for a variety of applications. However, metal ion battery cells are susceptible to various hazards during operation. For example, in some cases, an overcurrent can occur when the battery cell is overcharged and/or develops an internal short circuit. The latter can result from the failure of the separator between the anode and cathode of the battery cell. An internal short circuit can also develop due to various internal morphological deformations caused by parasitic reactions that occur during the repeated charging and discharging of the metal ion battery cell. Dendrites, which are formed by the accumulation of metal ions on the electrode of the battery cell, are one example of internal morphological deformations that can cause an internal short circuit. Whether the result of overcharging or an internal short circuit, overcurrent can cause irreversible damage to the battery cell. Moreover, overcurrent can lead to thermal runaway, a dangerous condition in which undissipated heat from the overcharging battery cell accelerates exothermic reactions within the battery cell to further exacerbate the precipitous rise in the temperature of the battery cell. The consequences of thermal runaway are dire and can include, for example, combustion, explosion, and/or the like. In particular, a failed metal ion battery undergoing thermal runaway will release flammable gases, which make battery fires especially fast spreading and difficult to contain.

### SUMMARY

Systems, methods, and articles of manufacture, including battery cells and battery cell components, are provided. In some implementations of the current subject matter, there is provided a battery cell that includes: a first electrode coupled with a first current collector; a second electrode coupled with a second current collector; a separator interposed between the first electrode and the second electrode; and a negative thermal expansion (NTE) current interrupter including a pyrophosphate, the negative thermal expansion (NTE) current interrupter contracting in response to a temperature trigger to form a nonconductive gap that disrupts a current flow within the battery cell.

In some variations of the methods, systems, and non-transitory computer readable media, one or more of the following features can optionally be included in any feasible combination.

In some variations, the negative thermal expansion (NTE) current interrupter may be interposed between the first electrode and the first current collector. The contracting of the negative thermal expansion (NTE) current interrupter may form the nonconductive gap between the first electrode and the first current collector.

In some variations, the negative thermal expansion (NTE) current interrupter may be interposed between the separator and at least one of the first electrode and the second electrode. The contracting of the negative thermal expansion (NTE) current interrupter may form the nonconductive gap between the separator and the at least one of the first electrode and the second electrode.

In some variations, the battery cell may further include a safe layer disposed on a surface of the negative thermal expansion (NTE) current interrupter, the safe layer causing a delamination in response to one or more of the temperature trigger, a voltage trigger, and a current trigger.

In some variations, the safe layer may cause the delamination by at least one of (i) decomposing, (ii) generating a gas, and (iii) generating a liquid that vaporizes to form the gas.

In some variations, the delamination may include at least one of (i) a separation of the safe layer into one or more separate layers and (ii) a separation of the safe layer from the negative thermal expansion (NTE) current interrupter.

In some variations, the delamination may form one or more additional nonconductive gaps that disrupt the current flow within the battery cell.

In some variations, the delamination may increase, along one or more dimensions, the nonconductive gap formed by the contracting of the negative thermal expansion (NTE) current interrupter.

In some variations, the contracting of the negative thermal expansion (NTE) current interrupter may include a decrease in a size of the negative thermal expansion (NTE) current interrupter along one or more dimensions.

In some variations, the contracting of the negative thermal expansion (NTE) current interrupter may be isotropic or anisotropic.

In some variations, the pyrophosphate may be a metal pyrophosphate.

In some variations, the pyrophosphate may be a copper pyrophosphate (CPO).

In some variations, the negative thermal expansion (NTE) current interrupter may include the pyrophosphate, polyvinylidene fluoride (PVDF), and carbon black dissolved in an N-methyl pyrrolidone (NMP) solvent.

In some variations, the pyrophosphate may be a pyrophosphate powder with particles that are less than 1-micron in size.

In some variations, battery cell may be thermally conditioned at 70° C.

In some variations, the battery cell may be a metal ion battery cell.

In some variations, the battery cell may be a cylindrical cell, a prismatic cell, a pouch cell, or a button cell.

In some variations, the first electrode may be a positive electrode and the second electrode may be a negative electrode.

In some variations, the first electrode may include a lithium metal oxide and the second electrode may include graphite.

In some variations, the first current collector may be aluminum (Al), and the second current collector may be copper (Cu).

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to lithium ion battery cells, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a schematic diagram illustrating an example of a battery cell, in accordance with some example embodiments;

FIG. 1B depicts a schematic diagram illustrating another example of a battery cell, in accordance with some example embodiments;

FIG. 1C depicts a schematic diagram illustrating another example of a battery cell, in accordance with some example embodiments;

FIG. 1D depicts a schematic diagram illustrating another example of a battery cell, in accordance with some example embodiments;

FIG. 2 depicts a series of optical microscope images illustrating the contraction of a coating that includes a negative thermal expansion (NTE) material, in accordance with some example embodiments;

FIG. 3 depicts a flowchart illustrating an example of a process for forming a battery cell, in accordance with some example embodiments;

FIG. 4A depicts a graph illustrating a comparison of the discharge profiles of various baseline battery cells without a negative thermal expansion (NTE) layer, in accordance with some example embodiments;

FIG. 4B depicts a graph illustrating a comparison of the discharge profiles of various battery cells with a negative thermal expansion (NTE) layer, in accordance with some example embodiments;

FIG. 4C depicts a graph illustrating a comparison of the discharge profiles of various battery cells with a safe layer in addition to a negative thermal expansion (NTE) composite layer, in accordance with some example embodiments;

FIG. 5A depicts a graph illustrating the thermal profile of a baseline battery cell without a negative thermal expansion (NTE) layer undergoing nail penetration test, in accordance with some example embodiments;

FIG. 5B depicts a graph illustrating the thermal profile of a battery cell with a negative thermal expansion (NTE) layer undergoing nail penetration test, in accordance with some example embodiments;

FIG. 5C depicts a graph illustrating the thermal profile of a battery cell with a negative thermal expansion (NTE) composite layer undergoing nail penetration test, in accordance with some example embodiments;

FIG. 5D depicts a graph illustrating the voltage and temperature profiles of a thermally conditioned battery cell with a negative thermal expansion (NTE) layer and thermal treatment undergoing nail penetration test, in accordance with some example embodiments; and

FIG. 5E depicts a graph illustrating the voltage and temperature profiles of an non-thermally conditioned battery cell with a negative thermal expansion (NTE) layer undergoing nail penetration test, in accordance with some example embodiments;

FIG. 5F depicts a graph illustrating the voltage and temperature profiles of a battery cell with a negative thermal expansion (NTE) composite layer undergoing nail penetration test, in accordance with some example embodiments; and

FIG. 5G depicts a graph illustrating the voltage and temperature profiles of a thermally conditioned battery cell without a negative thermal expansion (NTE) composite layer undergoing nail penetration test, in accordance with some example embodiments.

When practical, similar reference numbers denote similar structures, features, or elements.

### DETAILED DESCRIPTION

A battery cell can overcharge, overheat, and/or short circuit during operation. For example, overcurrent can occur in a battery cell when the battery cell is overcharged and/or develops an internal short circuit. In some cases, the battery cell can develop an internal short circuit as the result of compressive shocks to the battery cell and/or the growth of dendrites that form a low impedance path between the electrodes of the battery cell. Meanwhile, the battery cell can become overcharged when excess current is applied to battery cell, for example, when the battery cell is in a fully charged state. Both the internal short circuit and overcharging can cause irreversible damage to the battery cell. Furthermore, the internal short circuit and overcharging can lead to thermal runaway, a hazardous condition with dire consequences including, for example, fire, explosions, and/or the like. As such, in some implementations of the current subject matter, a battery cell may include a negative thermal expansion (NTE) based mechanism, such as a current interrupter that includes one or more negative thermal expansion (NTE) materials, to mitigate and/or eliminate the hazards that arise from overheating, overcharging, and/or short circuiting.

In some implementations of the current subject matter, the battery cell may include a first electrode (e.g., a positive electrode) coupled with a first current collector, a second electrode (e.g., a negative electrode) coupled with a second current collector, and a separator interposed between the first electrode and the second electrode. In some cases, the negative thermal expansion (NTE) current interrupter may be interposed between the first electrode and the first current collector and/or the second electrode and the second current collector. Alternatively and/or additionally, the negative thermal expansion (NTE) current interrupter may be interposed between a separator and the first electrode or the second electrode the battery cell. The negative thermal expansion (NTE) current interrupter may respond to a temperature trigger, such as when the battery cell is exposed to temperatures exceeding one or more thresholds, by contracting isotropically and/or anisotropically along one or more dimensions. The contraction of the negative thermal expansion (NTE) current interrupter may create a nonconductive gap that interrupts the flow of current through the battery cell, thereby neutralizing the risks associated with overheating, overcharging, and/or short circuiting.

In some implementations of the current subject matter, in addition to a negative thermal expansion (NTE) current interrupter, the safety profile of the battery cell may be further enhanced by coupling the negative thermal expansion (NTE) current interrupter with a safe layer. For example, in some cases, the safe layer may be disposed on a surface of the negative thermal expansion (NTE) current interrupter to form a negative thermal expansion (NTE) composite current interrupter. In some cases, the safe layer may include one or more materials that responds to a temperature trigger, a voltage trigger, and/or a current trigger by releasing a gas and/or a liquid that vaporizes to form a gas. For instance, the safe layer may release the gas and/or the liquid that vaporizes to form the gas when the temperature, voltage, and/or current at the battery cell satisfy one or more thresholds. The gas may cause a delamination of the safe layer and/or the negative thermal expansion (NTE) composite current interrupter coupled to the safe layer. In some cases, for example, the delamination of the negative thermal expansion (NTE) composite current interrupter may include a separation of the safe layer (e.g., into two or more constituent layers) and/or a separation of the safe layer from the negative thermal expansion (NTE) current interrupter coupled therewith. Accordingly, the delamination of the negative thermal expansion (NTE) composite current interrupter may form one or more additional nonconductive gaps and/or further increase the nonconductive gap created by the contraction of the negative thermal expansion (NTE) current interrupter. For instance, in cases the negative thermal expansion (NTE) current interrupter contracts along a first dimension to create a nonconductive gap along the first dimension, the safe layer may cause a delamination along a second dimension to further create a nonconductive gap along the second dimension.

In some implementations of the current subject matter, the negative thermal expansion (NTE) current interrupter may include one or more negative thermal expansion (NTE) materials that causes the negative thermal expansion (NTE) current interrupter to contract upon exposure to an increase in temperature and/or an above threshold temperature. The inclusion of some one or more negative thermal expansion (NTE) materials may have a negative impact on the performance of the battery cell under normal operating conditions. For example, the inclusion of some negative thermal expansion (NTE) materials may increase the impedance within the battery cell, thus diminishing the charge and discharge rate of the battery cell. The charge and discharge profile of the battery cell may be further impaired by the inclusion of a negative thermal expansion (NTE) composite current interrupter that incorporates a negative thermal expansion (NTE) current interrupter along with a safe layer. Accordingly, in some cases, the negative thermal expansion (NTE) current interrupter may include one or more negative thermal expansion (NTE) materials that maximize the performance of the battery cell. For instance, in some cases, the negative thermal expansion (NTE) current interrupter may include certain oxides including, for example, metal pyrophosphate (e.g., copper pyrophosphate such as Cu₂P₂O₇, a-Cu₂P₂O₇), Zn_{1.6}Mg_{0.4}P₂O₇, Zr₂S_{0.76}P₂O₁₂, and/or the like. Alternatively and/or additionally, the negative thermal expansion (NTE) current interrupter may include other oxides such as BiNi_{0.6}Fe_{0.4}O₃, Bi_{0.95}La_{0.05}NiO₃, 0.4PbTiO₃-0.6BiFeO₃, Pb_{0.5}Bi_{0.1}Sr_{0.1}VO₃, and Ti₂O₃. The inclusion of one or more of the aforementioned negative thermal expansion (NTE) material may increase the safety of the battery cell without compromising its performance.

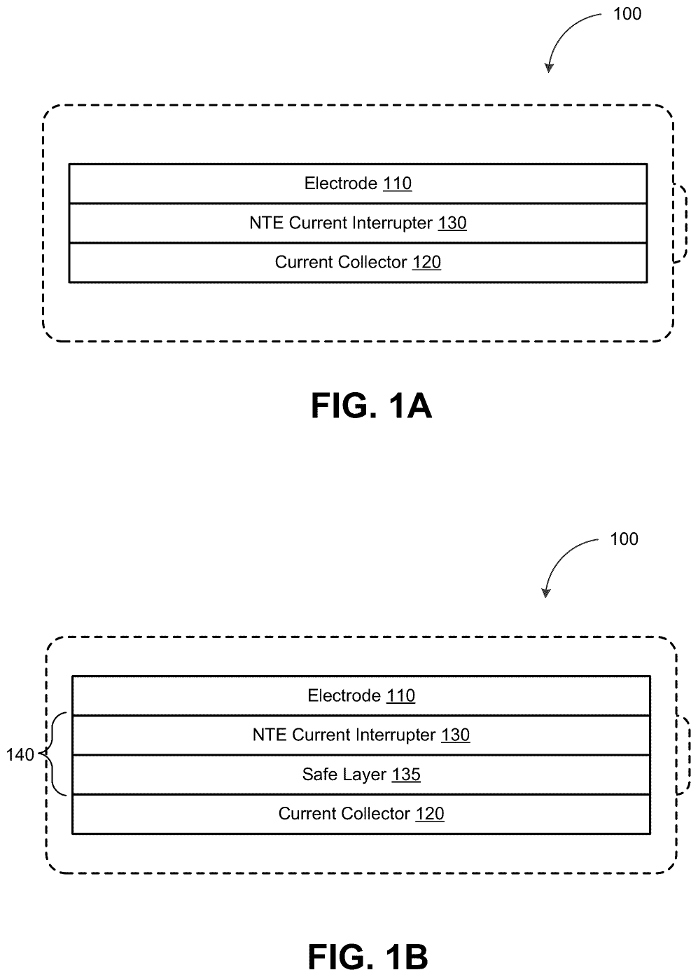

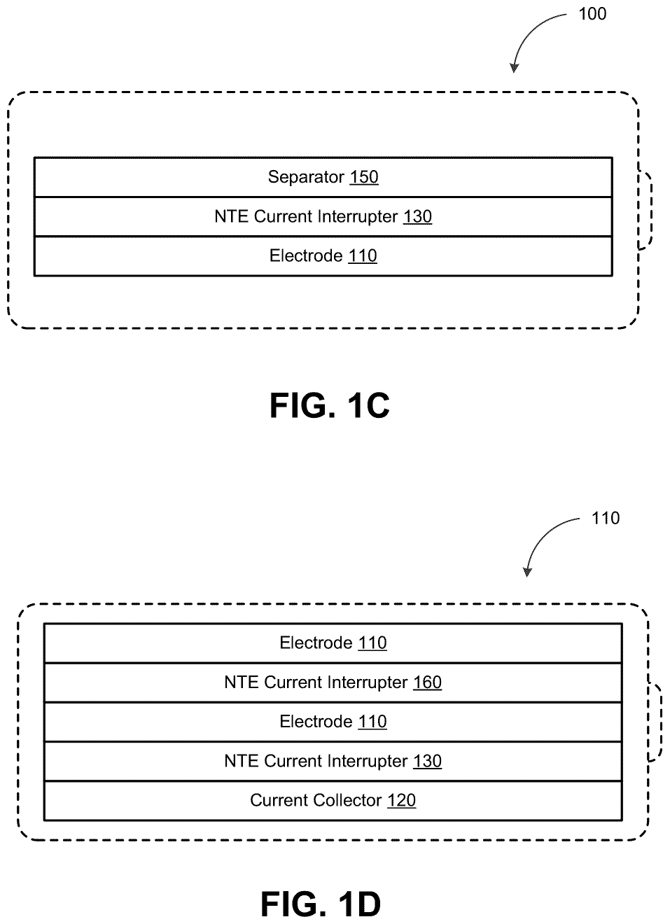

FIGS. 1A-D depict schematic diagrams illustrating examples of a battery cell 100 having a negative thermal expansion (NTE) based component consistent with implementations of the current subject matter. In some implementations of the current subject matter, the battery cell 100 may be a metal-ion battery cell including, for example, a lithium (Li) ion battery cell, a sodium (Na) ion battery cell, an aluminum (Al) ion battery cell, a potassium (K) ion battery cell, and/or the like. The battery cell 100 may also have a variety of different formats including, for example, a cylindrical cell, a pouch cell, a prismatic cell, a button cell, and/or the like. As shown in FIG. 1A, the battery cell 100 can include an electrode 110 and a current collector 120. The electrode 110 can be an anode and/or a cathode of the battery cell 100. Although not shown, the battery cell 100 can include another current collector that is coupled with another electrode having an opposite polarity as the electrode 110.

Referring again to FIG. 1A, in some cases, the battery cell 100 can include a negative thermal expansion (NTE) current interrupter 130 interposed between the electrode 110 and the current collector 120. Alternatively, in the example of the battery cell 100 shown in FIG. 1B, the negative thermal expansion (NTE) current interrupter 130 may be coupled with a safe layer 135 to form a negative thermal expansion (NTE) composite current interrupter 140. In the example shown in FIG. 1B, the negative thermal expansion (NTE) composite current interrupter 140 may be interposed between the electrode 110 and the current collector 120. Although FIG. 1B shows the negative thermal expansion (NTE) current interrupter 130 as being interposed between the electrode 110 and the safe layer 135, it should be appreciated that the safe layer 135 may be interposed between the electrode 110 and the negative thermal expansion (NTE) current interrupter 130 instead.

Referring now to FIG. 1C, the battery cell 100 can further include a separator 150 interposed between the two electrodes of the battery cell 100 including, for example, the electrode 110 and another electrode having an opposite polarity as the electrode 110. In some implementations of the current subject matter, in addition to or instead of being interposed between the electrode 110 and the current collector 120, the negative thermal expansion (NTE) current interrupter 130 (or the negative thermal expansion (NTE) composite current interrupter 140 including the negative thermal expansion (NTE) current interrupter 130 and the safe layer 135) may be interposed between the electrode 110 and a separator 150. FIG. 1D depicts another example of the battery cell 110 in which a layer of the negative thermal expansion (NTE) current interrupter 130 (or the negative thermal expansion (NTE) composite current interrupter 140 including the negative thermal expansion (NTE) current interrupter 130 and the safe layer 135) is interposed between successive layers of the electrode 110 as well as being interposed between the electrode 110 and the current collector 120.

In the examples shown in FIGS. 1A-D, the negative thermal expansion (NTE) current interrupter 130 may contract upon exposure to heat. For example, the negative thermal expansion (NTE) current interrupter 130 may undergo an isotropic contraction or an anisotropic contraction along one or more dimensions in response to an above-threshold temperature and/or an above threshold increase in temperature. In the case of isotropic contraction, the negative thermal expansion (NTE) current interrupter 130 may exhibit a decrease in the size of the negative thermal expansion (NTE) current interrupter that is uniform in all dimensions. Contrastingly, in the case of anisotropic contraction, the negative thermal expansion current interrupter 130 may exhibit a decrease in size that is not uniform across all directions. It should be appreciated that the manner in which the negative thermal expansion current interrupter 130 contracts (e.g., isotropically and/or anisotropically) can depend on a design (e.g., dimensions, shape, and/or the like) of the negative thermal expansion current interrupter 130 and/or the materials used to form the negative thermal expansion current interrupter 130.

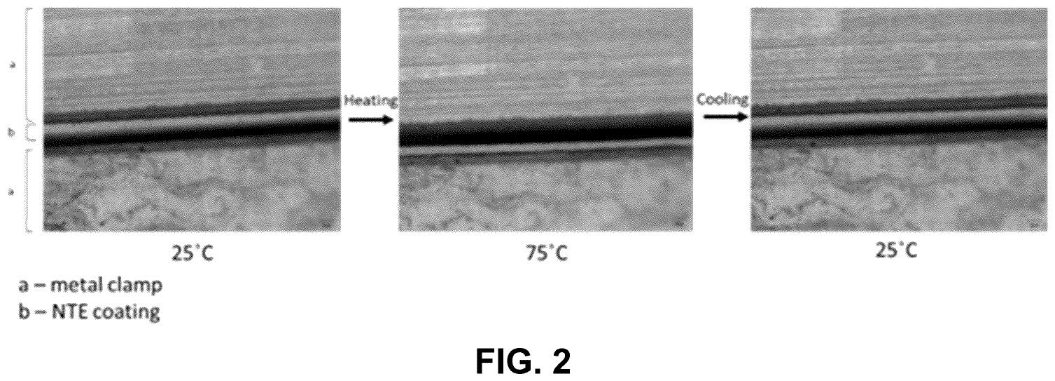

In some implementations of the current subject matter, the contraction of the negative thermal expansion current interrupter 130 can form a nonconductive gap within the battery cell 100, for example, between the electrode 110 and the current collector 120, the electrode 110 and the separator 140, and/or the like. For example, FIG. 2 depicts a series of optical microscope images illustrating the contraction of a coating that includes a negative thermal expansion (NTE) material. As shown in FIG. 2, the negative thermal expansion (NTE) coating (labeled “b”) between two metal clamps (labeled “a”) contracted in thickness by half (e.g., from 0.164 millimeters to 0.086 millimeters) when the negative thermal expansion (NTE) coating is heated from 25 C to 75 C and expanded when the negative thermal expansion (NTE) coating is cooled from 75 C to 25 C. Accordingly, in some cases, the nonconductive gap can be formed when the negative thermal expansion (NTE) current interrupter 130 contracts to at least partially detach from the electrode 110 and/or the current collector 120, thereby electrically decoupling the electrode 110 and the current collector 120. Alternatively and/or additionally, a nonconductive gap may be formed when the negative thermal expansion (NTE) current interrupter 130 contracts to at least partially detach from the separator 150 and/or the electrode 110.

It should be appreciated that the nonconductive gap can be full and/or a partial gap. Moreover, where the negative thermal expansion (NTE) current interrupter 130 is coupled with the safe layer 135, the safe layer 135 may enhance the formation of the nonconductive gap by releasing a gas and/or a liquid that vaporizes to form a gas. In some cases, the safe layer 135 may at least partially decompose, thus leaving a void that augments the nonconductive gap formed by the contraction of the negative thermal expansion (NTE) current interrupter 140. In instances where the contraction of the negative thermal expansion (NTE) current interrupter 130 creates a partial nonconductive gap along one or more dimensions, the safe layer 135 may operate to increase the partial nonconductive gap along the same and/or different dimensions. The presence of the nonconductive gap may interrupt a flow of current through the battery cell 100, thereby neutralizing the risks associated with overcharging, overheating, and/or internal short circuits.

In some implementations of the current subject matter, the negative thermal expansion current interrupter 130 can be formed from a material having negative thermal expansion properties including, for example, one or more oxides. For example, in some cases, the negative thermal expansion current interrupter 130 can be formed from one or more oxides such as a metal pyrophosphate (e.g., copper pyrophosphate (CPO)), Zn_{1.6}Mg_{0.4}P₂O₇, Zr₂S_{0.76}P₂O₁₂, BiNi_{0.6}Fe_{0.4}O₃, Bi_{0.95}La_{0.05}NiO₃, 0.4PbTiO₃-0.6BiFeO₃, Pb_{0.5}Bi_{0.1}Sr_{0.1}VO₃, Ti₂O₃, and/or the like. The inclusion of the negative thermal expansion (NTE) current interrupter 130 formed from the aforementioned negative thermal expansion (NTE) materials, instead of other known negative thermal expansion (NTE) materials, may preserve the performance of the battery cell 100. In particular, the inclusion of some negative thermal expansion (NTE) materials in the battery cell 100 may increase the impedance within the battery cell 100 and thus diminish its charge and discharge rate. Contrastingly, the inclusion of the aforementioned negative thermal expansion (NTE) materials in the negative thermal expansion (NTE) current interrupter 130 may maintain the charge and discharge profile of the battery cell 100 such that it remains comparable to that of a baseline battery cell formed without the negative thermal expansion (NTE) current interrupter 130.

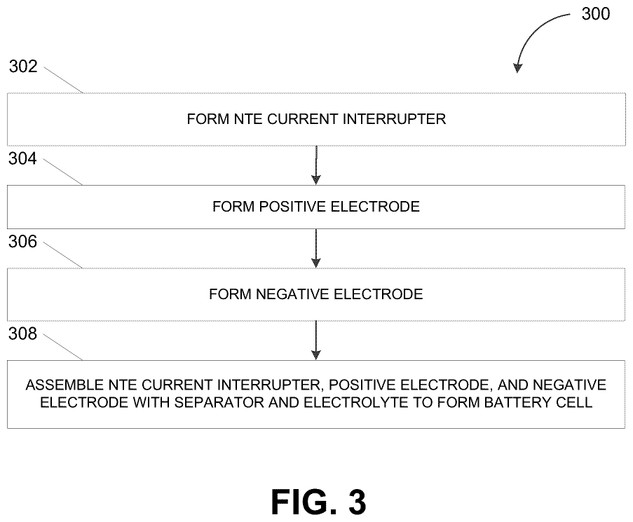

FIG. 3 depicts a flowchart illustrating an example of a process 300 for forming a battery cell, in accordance with some example embodiments. Referring to FIGS. 1A-D and 3, the process 300 may be performed to form one or more examples of the battery cell 100 shown in FIGS. 1A-D. In some implementations of the current subject matter, the process 200 may be performed to form the battery cell 100 to include the negative thermal expansion (NTE) current interrupter 130 and/or the negative thermal expansion (NTE) composite current interrupter 140 including the negative thermal expansion (NTE) current interrupter 130 and the safe layer 135.

At 302, a negative thermal expansion (NTE) current interrupter is prepared. For example, in some cases, the formation of the negative thermal expansion (NTE) current interrupter 130 may include dissolving polyvinylidene fluoride (PVDF) in N-methyl pyrrolidone (NMP) solvent (e.g., 1.98 grams of polyvinylidene fluoride (PVDF) in 32.7 grams of N-methyl pyrrolidone (NMP) solvent). The resulting polyvinylidene fluoride (PVDF) solution can be combined with carbon black (e.g., 0.1 grams of carbon black) and mixed, for example, for 15 minutes at 3000 revolutions per minute. This mixture is then combined with certain oxides such as a metal pyrophosphate (e.g., 7.92 grams of copper pyrophosphate powder), Zn_{1.6}Mg_{0.4}P₂O₇, Zr₂S_{0.76}P₂O₁₂BiNi_{0.6}Fe_{0.4}O₃, Bi_{0.9}La_{0.05}NiO₃, 0.4PbTiO₃-0.6BiFeO₃, Pb_{0.5}Bi_{0.1}Sr_{0.1}VO₃, and/or Ti₂O₃, and mixed, for example, for 30 minutes at 3000 revolutions per minute. The resulting slurry can be coated onto metal foil (e.g., 16 micrometer thickness aluminum (Al) foil) serving as the current collector 120, for example, using an automatic coating machine with multiple heating zones at approximately 75° C. to 80° C. In some cases, the negative thermal expansion (NTE) current interrupter 130 may be coupled with the safe layer 135, in which case a slurry for the safe layer 135 (e.g., a neutralized polyacrylic water solution) may be coated on the metal foil first before the slurry for the negative thermal expansion (NTE) current interrupter 130 is coated on the surface of the safe layer 135.

At 304, a positive electrode is prepared. For example, the formation of a positive electrode (or cathode) can include dissolving a binder into a solvent. A conductive additive and an active electrode material can be added to a binder solution to form a slurry. In some cases, the slurry is coated onto the surface of the negative thermal expansion (NTE) current interrupter 130 disposed on the current collector 120. Accordingly, in some cases, the positive electrode may be the electrode 110 disposed on the surface of the negative thermal expansion (NTE) current interrupter 130. The resulting assembly, which has the negative thermal expansion (NTE) current interrupter 130 interposed between the electrode 110 and the current collector 130, may be compressed into a desired thickness.

At 306, a negative electrode is prepared. For example, the preparation of the negative electrode (or anode) of the battery cell 100 may include dissolving carboxymethyl cellulose (CMC) in water (e.g., 14 grams of carboxymethyl cellulose (CMC) in 1077 grams of deionized water). The carboxymethyl cellulose (CMC) mixture may be combined with carbon black (e.g., 20 grams of carbon black) and mixed, for example, for 15 minutes at a rate of approximately 5000 revolutions per minute. The mixture may then be combined with synthetic graphite (e.g., 884 grams of synthetic graphite) and mixed, for example, for 30 minutes at 5000 rotations per minute. In addition, styrene butadiene rubber (e.g., 22 grams of styrene butadiene rubber (SBR) with a 50% solid content suspended in water) and polyimide (e.g., 3 grams of lithium neutralized polyimide) can be added to the mixture and mixed, for example, for 5 minutes at 5000 revolutions per minute. The resulting slurry can be coated onto metal foil (e.g., 6 micrometer thickness copper (Cu) foil) serving as the current collector, for example, using an automatic coating machine with multiple heat zones ranging from 100° C. to 130° C.

At 308, the negative thermal expansion (NTE) current interrupter, the positive electrode, and the negative electrode are assembled with a separator and an electrolyte to form a battery cell. For example, the positive and negative electrodes of the battery cell 100 can be formed by punching sheets of electrode material into appropriately shaped and/or sized pieces, for example, using an electrode tab. A layer of the separator 150 can be interposed between the electrodes of the battery cell 100 before the resulting assembly is formed into a cylindrical jellyroll, a flat jellyroll, or an electrode stack. The jellyroll or the electrode stack may be disposed in a canister or a composite bag before the package is dried. For instance, a flat jellyroll placed inside an aluminum (Al) composite bag may be dried at 70° C. for 10 hours. Thereafter, the package can be filled with an electrolyte and sealed to complete the assembly of the battery cell 100.

In some implementations of the current subject matter, the performance of the battery cell 100, which may include the negative thermal expansion (NTE) current interrupter 130, may be evaluated by comparison against that of a baseline battery cell without the negative thermal expansion (NTE) current interrupter 130. For example, in some cases, the charge and discharge rate of various examples of the battery cell 100 including the negative thermal expansion (NTE) current interrupter 130 may be compared against that of the baseline battery cell without the negative thermal expansion (NTE) current interrupter 130. Furthermore, nail penetration tests were performed in order to assess the thermal profiles of the battery cell 100 including the negative thermal expansion (NTE) current interrupter 130 relative to that of the baseline battery cell without the negative thermal expansion (NTE) current interrupter 130. The results of the performance evaluation are described below.

### Baseline Battery Cell

Preparation of Positive Electrode: The positive electrode (or cathode) of the baseline battery cell can be formed by dissolving 6 grams of polyvinylidene fluoride (PVDF) into 75 grams of N-methyl pyrrolidone (NMP). The polyvinylidene fluoride (PVDF) solution is then combined with 6 grams of carbon black and mixed for 15 minutes at a rate of 5000 revolutions per minute. Thereafter, 188 grams of nickel cobalt manganese (NMC) can be added to the mixture and mixed for an additional 30 minutes at 5000 revolutions per minute. The resulting slurry can then be coated onto the surface of 16-micron aluminum (Al) foil using an automatic coating machine with a heating zone between 85° C. to 135° C.

Preparation of Negative Electrode: The negative electrode (or anode) of the baseline battery cell can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, the baseline battery cell may be rendered as a pouch cell. Accordingly, the negative electrode is calendared to 180 microns in thickness while the positive electrode is calendared to 140 microns in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. The baseline battery cell is further filled with 4.25 milliliters of lithium ion carbonate-based electrolyte. The resulting baseline battery cell has a capacity of at least 2.5 ampere-hours and an impedance of <20 milliohms.

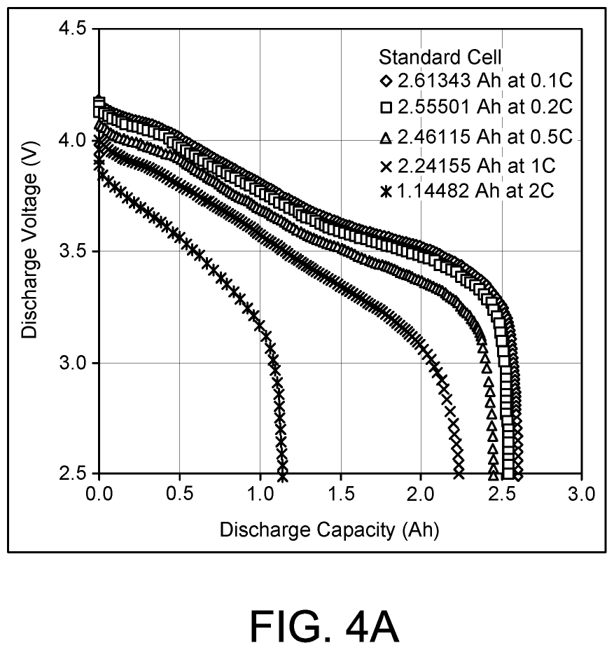

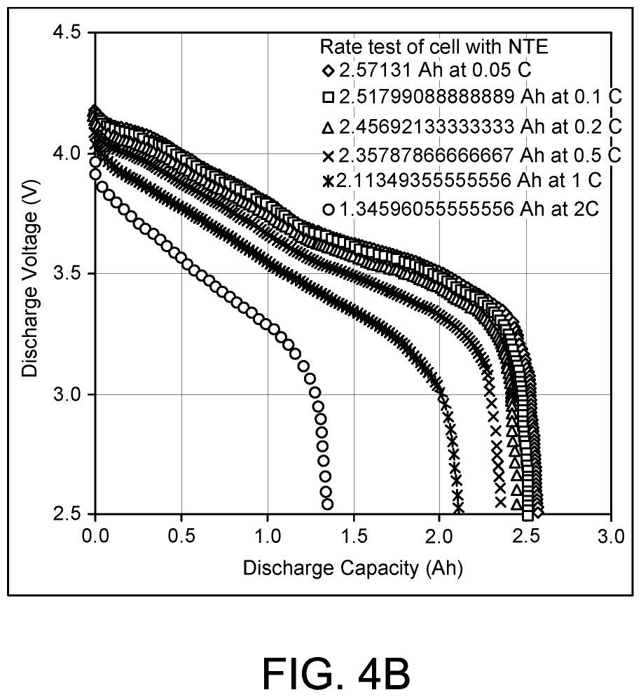

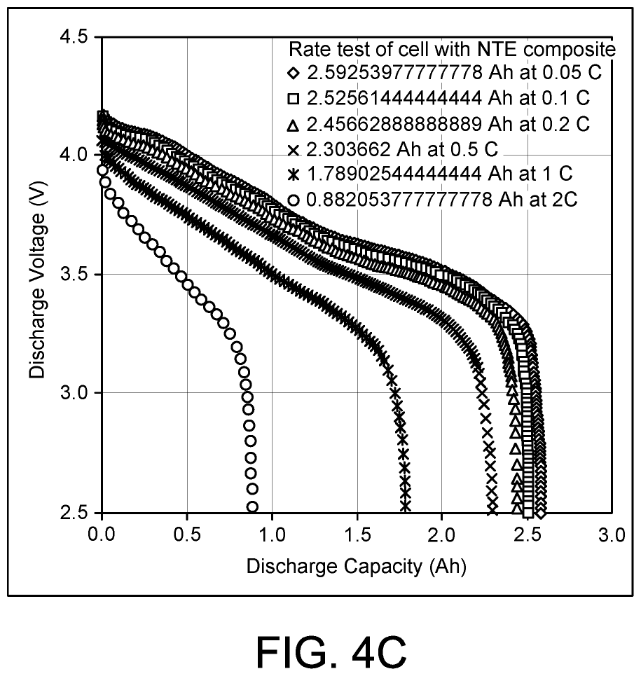

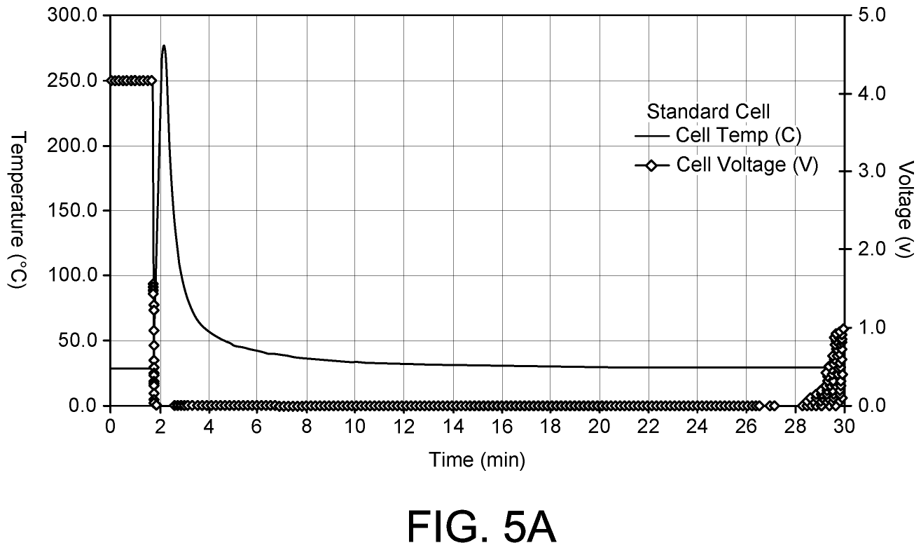

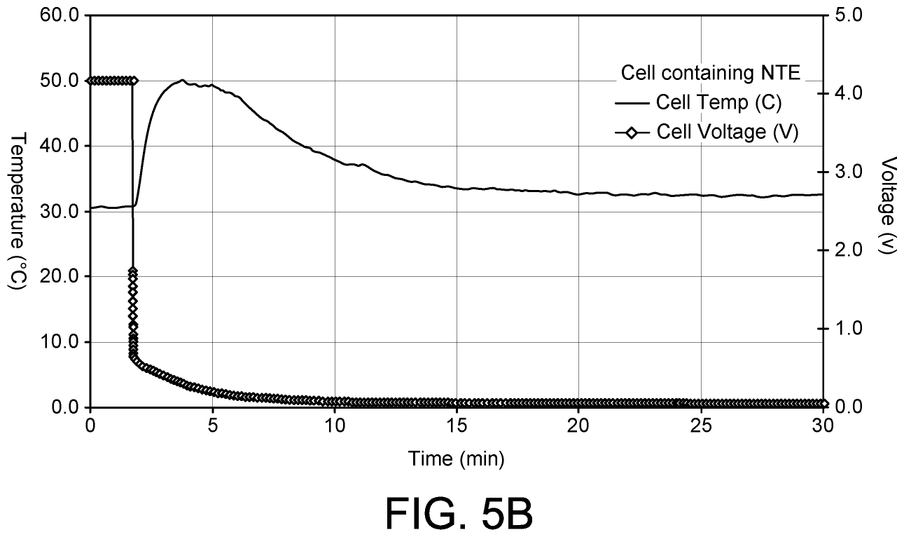

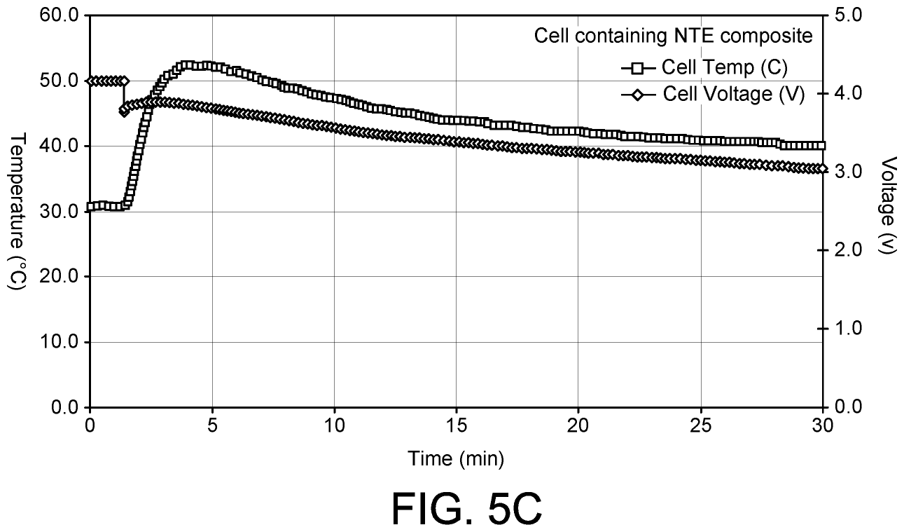

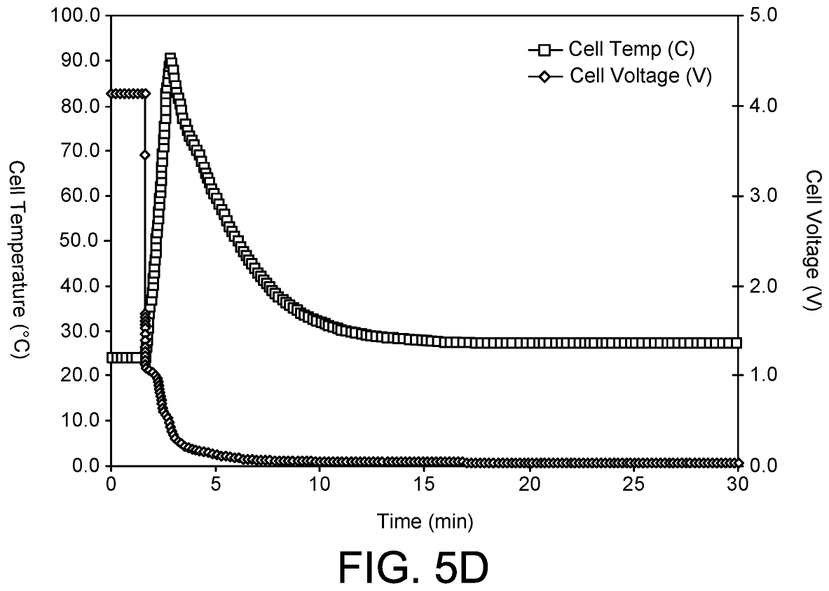

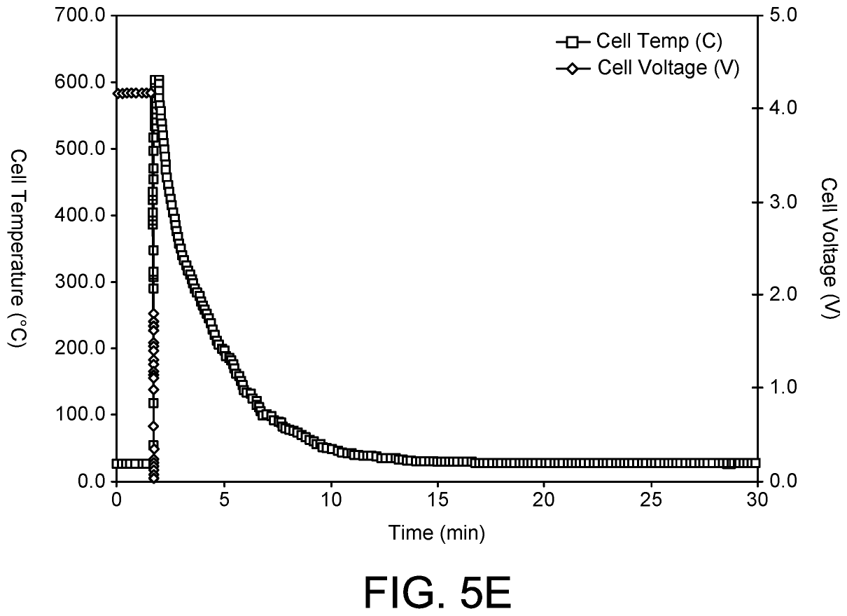

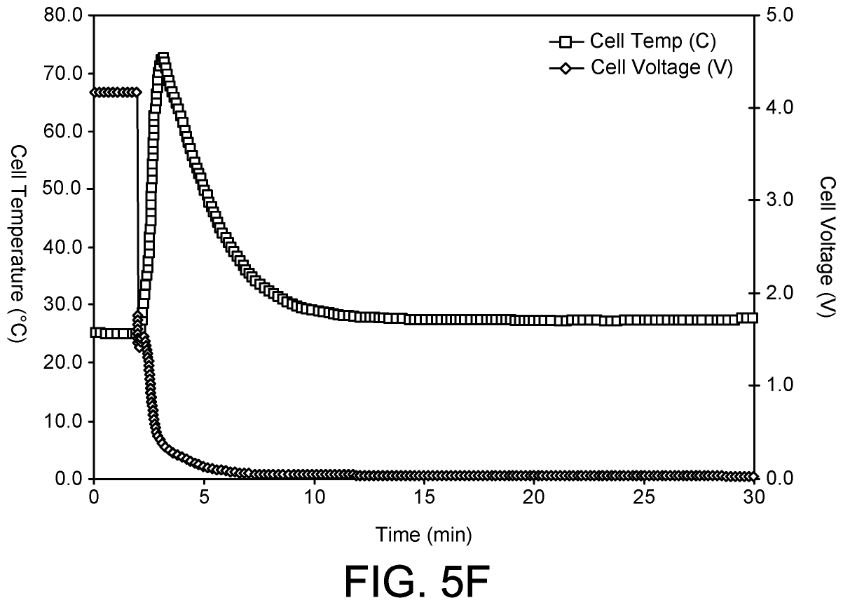

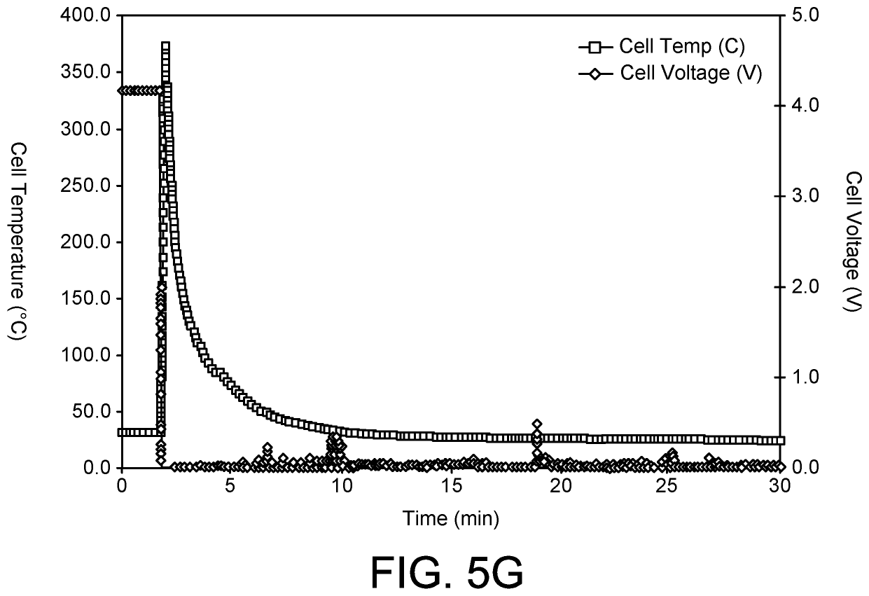

Cell Performance: FIG. 4A depicts a graph illustrating the charge and discharge profiles of various examples of baseline cells without a negative thermal expansion (NTE) current interrupter. FIG. 5A depicts a graph illustrating the thermal profile of a baseline cell without a negative thermal expansion (NTE) current interrupter during a nail penetration test. As shown in FIG. 5A, the temperature of the baseline battery cell exceeded 250° C. and a fire ultimately occurred in the absence of a negative thermal expansion (NTE) current interrupter.

### Example Battery Cell I

Preparation of Negative Thermal Expansion (NTE) Layer on Aluminum (Al) Foil: In some cases, a layer of negative thermal expansion (NTE) material can be formed by dissolving 1.98 grams of polyvinylidene fluoride (PVDF) in 32.7 grams of N-methyl pyrrolidone (NMP). The polyvinylidene fluoride (PVDF) solution can be combined with 0.1 grams of carbon black and mixed for 15 minutes at 3000 revolutions per minute. This mixture is then combined with 7.92 grams of copper pyrophosphate powder and mixed for 30 minutes at 3000 revolutions per minute. The resulting slurry can be coated onto 16-micron thick aluminum (Al) foil using an automatic coating machine with multiple heating zones at approximately 75° C. to 80° C.

Preparation of Positive Electrode: In some cases, Example Battery Cell I may include a lithium metal oxide (e.g. lithium nickel cobalt manganese (NMC) oxide, lithium cobalt oxide (LCO), and/or the like) positive electrode (or cathode) coupled with a graphite based negative electrode (or anode). The positive electrode (or cathode) of the Example Battery Cell I can be formed by dissolving 6 grams of polyvinylidene fluoride (PVDF) into 75 grams of N-methyl pyrrolidone (NMP). The resulting polyvinylidene fluoride (PVDF) solution is then combined with 6 grams of carbon black and mixed for 15 minutes at a rate of 5000 revolutions per minute. Thereafter, 188 grams of nickel cobalt manganese (NMC) can be added to the mixture and mixed for an additional 30 minutes at 5000 revolutions per minute. The resulting slurry is coated onto the surface of the negative thermal expansion (NTE) layer coated on aluminum (Al) foil, for example, using an automatic coating machine with a heating zone between 85° C. to 135° C.

Preparation of Negative Electrode: In some cases, the negative electrode (or anode) of Example Battery Cell I can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The resulting mixture is further combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, Example Battery Cell I may be rendered as a pouch cell. Accordingly, the negative electrode is calendared to 180 microns in thickness while the positive electrode is calendared to 140 microns in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. Example Battery Cell I is further filled with 4.25 milliliters of lithium ion carbonate-based electrolyte. The resulting Example Battery Cell I has a capacity of at least 2.5 ampere-hours and an impedance of <20 milliohms.

Cell Performance: FIG. 4B depicts a graph illustrating the charge and discharge profile of Example Battery Cell I. As shown in FIG. 4B, the inclusion of the negative thermal expansion (NTE) current interrupter did not adversely impact the rate capabilities of Example Battery Cell I, particularly relative to that of comparable baseline cells. FIG. 5B depicts a graph illustrating the thermal profile of Example Battery Cell I undergoing a nail penetration test. FIG. 5B shows the presence of the negative thermal expansion (NTE) current interrupter avoided a thermal runway by preventing the temperature of Example Battery Cell I from exceeding 50° C. whereas the temperature of the baseline cell without the negative thermal expansion (NTE) current interrupter exceeded 250° C. despite having an identical chemistry.

### Example Battery Cell II

Preparation of Safe Layer: Example Battery Cell II is formed to include a safe layer in addition to a negative thermal expansion (NTE) current interrupter. Accordingly, to form the safe layer, 2% polyacrylic acid water solution is neutralized by lithium hydrate oxide until a pH value around 8 is achieved. The neutralized polyacrylic water solution is then coated onto the surface of 15-micron thick aluminum (Al) foil with a loading of 0.2 mg/cm2 using a fully automatic slot die coater with two drying temperature zones (set to 75° C. and 85° C., respectively) and set to a coating speed is about 3 meters per minute.

Preparation of Negative Thermal Expansion (NTE) Layer on Safe Layer: In some cases, a layer of negative thermal expansion (NTE) material can be formed by dissolving 1.98 grams of polyvinylidene fluoride (PVDF) in 32.7 grams of N-methyl pyrrolidone (NMP). The polyvinylidene fluoride (PVDF) solution can be combined with 0.1 grams of carbon black and mixed for 15 minutes at 3000 revolutions per minute. This mixture is then combined with 7.92 grams of copper pyrophosphate powder and mixed for 30 minutes at 3000 revolutions per minute. The resulting slurry can be coated on the surface of the safe layer using an automatic coating machine with multiple heating zones at approximately 75° C. to 80° C.

Preparation of Positive Electrode: In some cases, the positive electrode (or cathode) of Example Battery Cell II can be formed by dissolving 6 grams of polyvinylidene fluoride (PVDF) into 75 grams of N-methyl pyrrolidone (NMP). The polyvinylidene fluoride (PVDF) solution is then combined with 6 grams of carbon black and mixed for 15 minutes at a rate of 5000 revolutions per minute. Thereafter, 188 grams of nickel cobalt manganese (NMC) can be added to the mixture and mixed for an additional 30 minutes at 5000 revolutions per minute. The resulting slurry can then be coated onto the surface of the negative thermal expansion (NTE) layer using an automatic coating machine with a heating zone between 85° C. to 135° C.

Preparation of Negative Electrode: The negative electrode (or anode) of Example Battery Cell II can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, Example Battery Cell II may be rendered as a pouch cell. Accordingly, the negative electrode is calendared to 180 microns in thickness while the positive electrode is calendared to 140 microns in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. Example Battery Cell I is further filled with 4.25 milliliters of lithium ion carbonate-based electrolyte. The resulting Example Battery Cell I has a capacity of at least 2.5 ampere-hours and an impedance of <30 milliohms.

Cell Performance: FIG. 4C depicts a graph illustrating the charge and discharge profiles of Example Battery Cell II. As shown in FIG. 4C, the presence of the safe layer in addition to the negative thermal expansion (NTE) layer diminished the rate capability of Example Battery Cell II as compared to the baseline cells. FIG. 5C depicts a graph illustrating the thermal profile of Example Battery Cell II undergoing a nail penetration test. FIG. 5C shows the presence of the negative thermal expansion (NTE) current interrupter in conjunction with the safe layer avoided a thermal runway by preventing the temperature of Example Battery Cell II from exceeding 55° C. whereas the temperature of the baseline cell without the negative thermal expansion (NTE) current interrupter exceeded 250° C. despite having an identical chemistry.

Table 1 below provides a summary of the characteristics of the baseline battery cell, Example Battery Cell I, and Example Battery Cell II.

TABLE 1

| | Impedance | Capacity | Nail Penetration Test |
|---|---|---|---|
| | (mΩ) | (Ah) | (at 4.2 V) |
| Baseline Battery | 15.41 | 2.4981 | Fail (Max T ≥ 250° C.) |
| Cell | | | |
| Example Battery | 15.9 | 2.4657 | Pass (Max T = 50° C.) |
| Cell I | | | |
| Example Battery | 21.87 | 2.4314 | Pass (Max T = 55° C.) |
| Cell II | | | |

### Example Battery Cell III

Preparation of Negative Thermal Expansion (NTE) Layer on Aluminum (Al) Foil with Ground Copper Pyrophosphate Powder: In some cases, approximately 50 grams of copper pyrophosphate (Cu₂P₂O₇ (CPO)) may be ground by being agitated inside two 100-milliliter zirconium oxide jars along with approximately 50 grams of 6-millimeter and 10-millimeter ceramic balls. The resulting copper pyrophosphate (CPO) particles may be less than 1-micron in size. Meanwhile, 2 grams of carbon black is mixed with 247.4 g of poly acrylic acid (carbopol) water solution (3.84%) neutralized by lithium hydroxide at a speed of >3000 revolutions per minute. The slurry then was mixed with 38.81 grams of the aforementioned ground copper pyrophosphate (CPO) particles first at 500 revolutions per minute then at 5000 revolutions per minute for 45 minute. The solid content of the resulting copper pyrophosphate (CPO) slurry is about 4%. Thereafter, the copper pyrophosphate (CPO) slurry is coated onto 16-micron thick aluminum (Al) foil using an automatic coating machine with six heating zones set at approximately 100° C., 105° C., 110° C., 120° C., and 120° C. The loading is approximately 0.64 milligrams per square centimeter.

Preparation of Positive Electrode: In some cases, Example Battery Cell III may include lithium metal oxide positive electrode (or cathode) that is formed by first mixing 13.6 grams of polyvinylidene fluoride (PVDF) with 156.4 grams of N-methyl pyrrolidone (NMP) solvent. Thereafter, 9.6 grams of carbon black is added to the polyvinylidene fluoride (PVDF) solution and mixed at 500 revolutions per minute first and then at 5000 revolutions per minute for 20 minutes. Then, 776 grams of LiNi0.8Co0.1Mn0.1O2 (NMC811) is added to the slurry and mixed first at 500 revolutions per minute and then at 5000 revolutions per minute for 25 minutes. The slurry temperature during the mixing is controlled to prevent the slurry from gelling. Finally, 200 grams of carbon nano tube in a 0.4% carbon nano tube N-methyl pyrrolidone (NMP) suspension solution is added to the slurry and mixed at 1000 revolutions per minute. The final solid content of the slurry is adjusted to about 56.7% with some additional N-methyl pyrrolidone (NMP) solvent in order to achieve a smooth consistency. The resulting slurry is then be coated on the surface of the negative thermal expansion (NTE) layer using an automatic coating machine with a heating zone set between 85° C. to 135° C. The electrode loading is approximately 23 milligrams per square centimeter. The positive electrode is then dried in a vacuum oven set at 125° C. for at least 12 hours prior to being calendared to the target thickness for cell assembly.

Preparation of Negative Electrode: The negative electrode (or anode) of Example Battery Cell II can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, Example Battery Cell III may be rendered as a pouch cell. Accordingly, the negative electrode is calendared to 180 microns in thickness while the positive electrode is calendared to 140 microns in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. A jelly flat formed from the stacked positive electrode sheets, separator, and negative electrode sheets is dried in a vacuum oven set at 80° C. for 12 hours before being filled with 4.25 milliliters of a lithium-ion carbonate-based electrolyte. Once filled and sealed, Example Battery Cell III is aged at room temperature for 24 hours and then formed with a standard formation procedure with an initial charging current C/20 rate. Example Battery Cell III is charged to 4.2V at C/5 rate for six hours and then discharged to 2.5V at C/20 and C/10 rates respectively. While six Example Battery Cell III were formed, three underwent a thermal treatment at 70° C. for two hours and three did not. Table 2 below provides capacities of battery cells 1, 2, 4, and 5 prior to thermal treatment.

TABLE 2

| | | | Charge | |
|---|---|---|---|---|
| | Cell | Discharge | capacity at | Discharge |
| | impedance | capacity at | C/5 to 4.2 V | capacity at |
| Cell | at 1 kHz | C/20 to 2.5 V | for 6 hours | C/10 to 2.5 V |
| ID | (mohm) | (Ah) | (Ah) | (Ah) |
| 1 | 13.8 | 2.4919 | 2.4918 | 2.2879 |
| 2 | 13.1 | 2.4711 | 2.4813 | 2.4248 |
| 4 | 12.8 | 2.4837 | 2.499 | 2.4413 |
| 5 | 12.7 | 2.4852 | 2.4943 | 2.437 |

Cell Performance: Three fully charged Example Battery Cell III (cell numbers 1, 2, 3) (4.2V) underwent thermal treatment at 70° C. for two hours before being degassed and undergoing rate capability testing. Meanwhile, cell numbers 4, 5, and 6 were not subjected to thermal treatment prior to being degassed and undergoing rate capability testing. During rate capability testing, each Example Battery Cell III was i) charged to 4.2 volts at 2 amperes for two hours, ii) rest for ten minutes, iii) discharged to 2.5 volts at 0.5 amperes, iv) rest for 30 minutes, v) charged to 4.2 volts at 2 amperes for two hours, vi) rest for ten minutes, vii) discharged to 2.5 volts at 1.25 amperes, viii) rest for 30 minutes, ix) charged to 4.2 volts at 2 amperes for two hours, x) rest for ten minutes, xi) discharged to 2.5 volts at 2.5 amperes, xii) rest for 30 minutes, xiii) charged to 4.2 volts at amperes for two hours, xiv) rest for ten minutes, xv) discharged to 2.5 volts at 5 amperes, and xvi) rest for 30 min. As shown in Table 3 below, thermal treatment did not impact cell capacity or impedance.

FIG. 5D depicts a graph illustrating the temperature and voltage profiles of those Example Battery Cell III (cell numbers 1, 2, 3) (4.2V) that underwent thermal treatment. As shown in FIG. 5D, the voltage of the battery cells declined rapidly while the temperature of the battery cell increased precipitously upon penetration by the nail. However, those battery cells passed the nail penetration test as maximum temperature reached only 92° C. Meanwhile FIG. 5E depicts a graph illustrating the voltage and temperature profiles of those Example Battery Cell III (cell numbers 4, 5, 6) that did not undergo thermal treatment and failed in the nail test. As shown in FIG. 5E, the voltage of these battery cells declined rapidly while the temperature of the battery cells reached >600° C. upon penetration by the nail. For comparison, FIG. 5G shows that baseline cells without a negative thermal expansion (NTE) layer that are subjected to thermal conditioning also failed the nail penetration test, with cell temperature reaching >350° C. Thus, the safety of the battery cell is further improved when a negative thermal expansion (NTE) layer is combined with thermal conditioning.

TABLE 3

| | Cell | Discharge | Discharge | Discharge | Discharge | Thermal |
|---|---|---|---|---|---|---|
| | impedance | capacity at | capacity at | capacity at | capacity at | Treatment |
| Cell | at 1 kHz | C/5 or 0.5 A | C/2 or 1.25 A | 1 C or 2.5 A to | 1 C or 5 A to | at 70° C. for |
| ID | (mohm) | to 2.5 V (Ah) | to 2.5 V (Ah) | 2.5 V (Ah) | 2.5 V (Ah) | 2 hours |
| 1 | 13.3 | 2.2658 | 2.0589 | 1.6355 | 0.7737 | yes |
| 2 | 12.2 | 2.4077 | 2.1685 | 1.7251 | 0.8334 | yes |
| 4 | 12.7 | 2.3986 | 2.2652 | 1.9167 | 0.9335 | No |
| 5 | 12.6 | 2.3705 | 2.2209 | 1.7802 | 0.8487 | No |

### Example Battery Cell IV

Preparation of Thick Negative Thermal Expansion (NTE) Layer on Aluminum (Al) foil: Example Battery Cell IV is formed to include a thicker layer of negative thermal expansion (NTE) material than Example Battery Cells I, II, and III. The negative thermal expansion (NTE) layer is prepared by mixing 5 grams of carbon black with 614.58 grams of poly acrylic acid (or carbopol) water solution (3.84%) neutralized by lithium hydroxide at >5000 revolutions per minute. The slurry is then combined was with 212.8 grams of copper pyrophosphate (CPO) at 5000 revolutions per minute for 45 min. The viscosity of the slurry is adjusted, for example, by adding water to reach to final solid content of about 6%. The copper pyrophosphate (CPO) slurry is coated onto 16-micron thick aluminum (Al) foil using an automatic coating machine with six heating zones set at approximately 100° C., 105° C., 110° C., 120° C., and 120° C. The loading is about 1 milligrams per square centimeter, as opposed to 0.64 milligrams per square centimeter for Example Battery Cell III.

Preparation of Positive Electrode: The positive electrode (or cathode) of Example Battery Cell IV is prepared by first mixing 42.5 grams of polyvinylidene fluoride (PVDF) with 488.75 grams of N-methyl pyrrolidone (NMP) solvent to form a solution that is then mixed with 30 grams of carbon black at 5000 revolutions per minute for 20 minutes. Thereafter, 2425 grams of LiNi0.8Co0.1Mn0.1O2 (NMC811) plus 622.5 grams of N-methyl pyrrolidone (NMP) solvents are added to the slurry and mixed first at 500 revolutions per minute and then at 5000 revolutions per minute for 25 minute. The temperature of the slurry is controlled during the mixing in order to prevent the slurry from gelling. Finally, 625 grams of carbon nano tube with 0.4% carbon nano tube N-methyl pyrrolidone (NMP) suspension solution is added to the slurry and mixed at 1000 revolutions per minute. The final solid content of the slurry is adjusted to about 57% by the addition of N-methyl pyrrolidone (NMP) solvent (774.75g in total) to achieve a smooth consistency. The resulting slurry is coated onto the surface of the negative thermal expansion (NTE) layer on the aluminum (Al) foil using an automatic coating machine with a single heating zone set between 85° C. to 135° C. The electrode loading is approximately 23 milligrams per square centimeter. The positive electrode is then dried in a vacuum oven set at 125° C. for at least 12 hours prior to being calendared to the target thickness for cell assembly.

Preparation of Negative Electrode: The negative electrode (or anode) of Example Battery Cell IV can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, Example Battery Cell IV may be rendered as a pouch cell. Accordingly, the negative electrode is calendared to 180 microns in thickness while the positive electrode is calendared to 140 microns in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. A jelly flat formed from the stacked positive electrode sheets, separator, and negative electrode sheets is dried in a vacuum oven set at 80° C. for 12 hours before being filled with 4.25 milliliters of a lithium-ion carbonate-based electrolyte. Once filled and sealed, Example Battery Cell IV is aged at room temperature for 24 hours and then formed with a standard formation procedure with an initial charging current C/20 rate. Example Battery Cell IV is charged to 4.2V at C/5 rate for six hours and then discharged to 2.5V at C/20 and C/10 rates respectively. While six Example Battery Cell IV were formed, all underwent a thermal treatment at 70° C. for two hours. Table 4 below provides capacities of battery cells 1, 2, 4, and 5 prior to thermal treatment.

TABLE 4

| | | | Charge | |
|---|---|---|---|---|
| | Cell | Discharge | capacity at | Discharge |
| | impedance | capacity at | C/5 to 4.2 V | capacity at |
| Cell | at 1 kHz | C/20 to 2.5 V | for 6 hours | C/10 to 2.5 V |
| ID | (mohm) | (Ah) | (Ah) | (Ah) |
| 1 | 14.1 | 2.5001 | 2.5145 | 2.4509 |
| 2 | 14.2 | 2.4726 | 2.5484 | 2.4417 |
| 4 | 14.41 | 2.4978 | 2.5097 | 2.4486 |
| 5 | 14.65 | 2.4929 | 2.5045 | 2.4421 |

Cell Performance: Three fully charged Example Battery Cell IV (cell numbers 1, 2, 3) (4.2V) underwent thermal treatment at 70° C. for two hours before being degassed and undergoing rate capability testing. During rate capability testing, each Example Battery Cell IV was i) charged to 4.2 volts at 2 amperes for two hours, ii) rest for ten minutes, iii) discharged to 2.5 volts at 0.5 amperes, iv) rest for 30 minutes, v) charged to 4.2 volts at 2 amperes for two hours, vi) rest for ten minutes, vii) discharged to 2.5 volts at 1.25 amperes, viii) rest for 30 minutes, ix) charged to 4.2 volts at 2 amperes for two hours, x) rest for ten minutes, xi) discharged to 2.5 volts at 2.5 amperes, xii) rest for 30 minutes, xiii) charged to 4.2 volts at amperes for two hours, xiv) rest for ten minutes, xv) discharged to 2.5 volts at 5 amperes, and xvi) rest for 30 min. As shown in Table 4 and Table 5 below, presence of a thicker negative thermal expansion (NTE) layer (e.g., with a higher loading of 1 milligram per square centimeter) engendered a slight increase in the impedance of Example Battery Cell IV compared to Example Battery Cell III, which is formed with a thinner negative thermal expansion (NTE) layer (e.g., lower loading of 0.62 milligrams per square centimeter). Nevertheless, the presence of a negative thermal expansion (NTE) layer, including a thicker negative thermal expansion (NTE) layer with a higher loading (e.g., 1 milligram per square centimeter) does not impact the impedance of a battery cell significantly,

FIG. 5G depicts a graph illustrating the temperature and voltage profiles of each individual Example Battery Cell IV when subjected to nail penetration tests (e.g., with a 3-millimeter diameter round tip nail at room temperature). While the voltage of the cell declined rapidly and its temperature increased quickly upon penetration by the nail, the cell passed the test with the maximum cell temperature being ˜75° C.

TABLE 5

| | | Discharge | Discharge | Discharge | Discharge |
|---|---|---|---|---|---|
| | | capacity | capacity | capacity | capacity |
| | Cell | at C/5 or | at C/2 or | at 1C or | at 1C or |
| | impedance | 0.5 A to | 1.25 A to | 2.5 A to | 5 A to |
| Cell | at 1 kHz | 2.5 V | 2.5 V | 2.5 V | 2.5 V |
| ID | (mohm) | (Ah) | (Ah) | (Ah) | (Ah) |
| 1 | 13.59 | 2.3808 | 2.0612 | 1.4709 | 0.7515 |

### Example Battery Cell V

Preparation of Positive Electrode: The positive electrode (or cathode) of Example Battery Cell V is prepared by mixing 42.5 grams of polyvinylidene fluoride (PVDF) with 488.75 grams of N-methyl pyrrolidone (NMP) solvent to form a solution. Thereafter, 30 grams of carbon black was added to the polyvinylidene fluoride (PVDF) solution and mixed first at low speed then high speed for 20 minutes. Then, 2425 grams of LiNi0.8Co0.1Mn0.1O2 (NMC811) plus 1243 grams N-methyl pyrrolidone (NMP) solvent is added to the slurry and mixed at the high speed for 25 minutes. The temperature of the slurry is controlled during the mixing in order to prevent the slurry from gelling. Finally, 625 grams of carbon nano tube with 0.4% carbon nano tube N-methyl pyrrolidone (NMP) suspension solution is added to the slurry and mixed at low speed. The final solid content is adjusted to about 59.07% with additional N-methyl pyrrolidone (NMP) solvent to achieve a smooth consistency. The resulting slurry is coated onto aluminum (Al) foil using an automatic coating machine with a single heating zone set between 85° C. to 135° C. The loading of the positive electrode is about 23 milligrams per square centimeter. The positive electrode is dried in a vacuum oven at 125° C. for >12 hours and then calendared to the target thickness prior to cell assembly.

Preparation of Negative Electrode: The negative electrode (or anode) of Example Battery Cell V can be formed by dissolving 14 grams of carboxymethyl cellulose (CMC) into 1077 grams of deionized water. The carboxymethyl cellulose (CMC) mixture is then combined with 20 grams of carbon black for 15 minutes at a rate of approximately 5000 revolutions per minute. The mixture is then combined with 884 grams of synthetic graphite and mixed for 30 minutes at 5000 rotations per minute. In addition, 22 grams of styrene butadiene rubber (SBR) with a 50% solid content suspended in water and 3 grams of lithium neutralized polyimide can be added to the mixture and mixed for 5 minutes at 5000 revolutions per minute. The slurry is then coated onto 6-micron thick copper (Cu) foil using an automatic coating machine with multiple heat zones ranging from 100° C. to 130° C.

Cell Assembly: In some cases, Example Battery Cell V is rendered in a pouch format. The negative electrode (or anode) is calendared to 180 micrometers in thickness while the positive electrode (or cathode) is calendared to 162 micrometers in thickness. The negative electrode is further cut into 34×58.5 millimeter sheets while the positive electrode is cut into 33×57.5 millimeter sheets. Sixteen positive electrode sheets are then stacked to alternate with seventeen negative electrode sheets with a separator (e.g., a 25-micron thick poly ethylene based separator) interposed between the alternating negative electrode and positive electrode sheets. The baseline battery cell is further filled with 4.25 milliliters of lithium ion carbonate-based electrolyte. Once sealed, Example Battery Cell V is aged at room temperature for 24 hours and then formed with a standard formation procedure with the low initial charging current C/20 rate. Example Battery Cell V is then charged to 4.2 volts at C/5 rate for six hours before being discharged to 2.5 volts at C/20 and C/10 rates respectively. Table 6 below lists the capacity of Example Battery Cell V prior to undergoing a two-hour thermal treatment at 70° C.

TABLE 6

| | Cell | Discharge | Charge capacity | Discharge |
|---|---|---|---|---|
| | impedance | capacity at | at C/5 to 4.2 V | capacity at |
| Cell | at 1 kHz | C/20 to 2.5 V | for 6 hours | C/10 to 2.5 V |
| ID | (mohm) | (Ah) | (Ah) | (Ah) |
| 1 | 12.43 | 2.4954 | 2.5067 | 2.4838 |
| 2 | 12.45 | 2.4954 | 2.5079 | 2.4819 |
| 3 | 12.15 | 2.4927 | 2.5042 | 2.4795 |
| 5 | 12.66 | 2.4816 | 2.5023 | 2.4770 |

As shown Tables 4, 5, and 6, the impedance of a battery cell without a negative thermal expansion (NTE) layer is similar to those with a negative thermal expansion (NTE) layer. Example Battery Cell V is also subjected to a nail penetration test in which a round tip nail that is 3 millimeters in diameter is inserted into the battery cell while the voltage and the temperature of the battery cell are measured. FIG. 5G depicts a graph illustrating the voltage and temperature profiles of Example Battery Cell V undergoing a nail penetration test after the battery cell has undergone thermal conditioning at 70° C. for two hours. Example Battery Cell V failed the nail penetration test at >350° C., indicating that thermal conditioning alone (without a negative thermal expansion (NTE) layer) is insufficient for ensuring the operational safety of battery cells during a thermal runaway.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A battery cell, comprising:
a first electrode coupled with a first current collector;
a second electrode coupled with a second current collector;
a separator interposed between the first electrode and the second electrode; and
a negative thermal expansion (NTE) current interrupter including a pyrophosphate, the negative thermal expansion (NTE) current interrupter contracting in response to a temperature trigger to form a nonconductive gap that disrupts a current flow within the battery cell.

2. The battery cell of claim 1, wherein the negative thermal expansion (NTE) current interrupter is interposed between the first electrode and the first current collector, and wherein the contracting of the negative thermal expansion (NTE) current interrupter forms the nonconductive gap between the first electrode and the first current collector.

3. The battery cell of claim 1, wherein the negative thermal expansion (NTE) current interrupter is interposed between the separator and at least one of the first electrode and the second electrode, and wherein the contracting of the negative thermal expansion (NTE) current interrupter forms the nonconductive gap between the separator and the at least one of the first electrode and the second electrode.

4. The battery cell of claim 1, further comprising:
a safe layer disposed on a surface of the negative thermal expansion (NTE) current interrupter, the safe layer causing a delamination in response to one or more of the temperature trigger, a voltage trigger, and a current trigger.

5. The battery cell of claim 4, wherein the safe layer causes the delamination by at least one of (i) decomposing, (ii) generating a gas, and (iii) generating a liquid that vaporizes to form the gas.

6. The battery cell of claim 4, wherein the delamination includes at least one of (i) a separation of the safe layer into one or more separate layers and (ii) a separation of the safe layer from the negative thermal expansion (NTE) current interrupter.

7. The battery cell of claim 4, wherein the delamination forms one or more additional nonconductive gaps that disrupt the current flow within the battery cell.

8. The battery cell of claim 4, wherein the delamination increases the nonconductive gap formed by the contracting of the negative thermal expansion (NTE) current interrupter along one or more dimensions.

9. The battery cell of claim 1, wherein the contracting of the negative thermal expansion (NTE) current interrupter includes a decrease in a size of the negative thermal expansion (NTE) current interrupter along one or more dimensions.

10. The battery cell of claim 1, wherein the contracting of the negative thermal expansion (NTE) current interrupter is isotropic or anisotropic.

11. The battery cell of claim 1, wherein the pyrophosphate is a metal pyrophosphate.

12. The battery cell of claim 1, wherein the pyrophosphate is a copper pyrophosphate (CPO).

13. The battery cell of claim 1, wherein the negative thermal expansion (NTE) current interrupter includes the pyrophosphate, polyvinylidene fluoride (PVDF), and carbon black dissolved in an N-methyl pyrrolidone (NMP) solvent.

14. The battery cell of claim 1, wherein the pyrophosphate is a pyrophosphate powder with particles that are less than 1-micron in size.

15. The battery cell of claim 1, wherein the pyrophosphate (CPO) is

16. The battery cell of claim 1, wherein the battery cell is a metal ion battery cell.

17. The battery cell of claim 1, wherein the battery cell is a cylindrical cell, a prismatic cell, a pouch cell, or a button cell.

18. The battery cell of claim 1, wherein the first electrode is a positive electrode and the second electrode is a negative electrode.

19. The battery cell is claim 1, wherein the first electrode includes a lithium metal oxide and the second electrode includes graphite.

20. The battery cell of claim 1, wherein the battery cell is thermally conditioned at 70° C. for two hours.
